(19) United States
(12) Patent Application Publication
(10) Pub. No.: US 2022/0205562 A1
(43) Pub. Date: Jun. 30, 2022

(54) TUBE AND METHOD FOR MAKING SAME

(71) Applicant: SAINT-GOBAIN PERFORMANCE PLASTICS CORPORATION, Solon, OH (US)

(72) Inventors: Katie Campbell, Northborough, MA (US); Josef E. Guesman, Uniontown, OH (US); John J. Heindel, Bordentown, NJ (US); Michael J. Tzivanis, Chicopee, MA (US); Stephan Chassee, Kaarst (DE); Anne Gierens, Levallois-Perret (FR); Qiaoxi Li, Waltham, MA (US)

(21) Appl. No.: 17/646,166

(22) Filed: Dec. 28, 2021

Related U.S. Application Data
(60) Provisional application No. 63/131,523, filed on Dec. 29, 2020.

(51) Int. Cl. F16L 11/04; B29C 48/09; B29C 48/21; B29C 35/10

(52) U.S. Cl. CPC F16L 11/04; B29C 48/09; F16L 2011/047; B29C 35/10; B29C 48/21

(57) ABSTRACT

A tube includes at least one fluoropolymer layer, the tube having an inner surface and an outer surface, wherein the at least one fluoropolymer layer includes a fluoropolymer having a heat shrink temperature of less than 250° C., wherein the outer surface of the tube is crosslinked and the inner surface of the tube is not crosslinked.

### CROSS REFERENCE TO RELATED APPLICATION(S)

This application claims priority under 35 U.S.C. § 119(e) to U.S. Provisional Application No. 63/131,523, entitled “TUBE AND METHOD FOR MAKING SAME,” by Katie CAMPBELL et al., filed Dec. 29, 2020, which is assigned to the current assignee hereof and incorporated herein by reference in its entirety.

### FIELD OF THE DISCLOSURE

This application in general, relates to a tube and a method for making same, and in particular, relates to a heat shrink tube.

### BACKGROUND

In many industries, sensors are placed in various environments to measure a variety of conditions. An insulating covering may be placed over the sensor to protect the sensors from conditions that could damage the sensor. Typically, a covering is placed over the sensor and heated to “heat shrink” the covering to encapsulate the sensor. Commercially available products used as an insulating covering include low surface energy polymers, such as fluoropolymers. Fluoropolymer exhibit good chemical barrier properties, exhibit a resistance to damage caused by exposure to chemicals, have a resistance to stains, and demonstrate a resistance to damage caused by exposure to environmental conditions. While such low surface energy polymers are desirable due to their chemical resistance, current commercially available products have a high temperature to shrink, such as in excess of 300° C.

Accordingly, in view of the foregoing, there is a continuous need in the industry for improvements in heat shrink tubing that has desirable encapsulation and low temperature shrink.

### SUMMARY

In an embodiment, a tube includes at least one fluoropolymer layer, the tube having an inner surface and an outer surface, wherein the at least one fluoropolymer layer includes a fluoropolymer having a heat shrink temperature of less than 250° C., wherein the outer surface of the tube is crosslinked and the inner surface of the tube is not crosslinked.

In another embodiment, a method of forming a tube includes providing a fluoropolymer having a heat shrink temperature of less than 250° C.; extruding the fluoropolymer into at least one fluoropolymer layer, the tube having an inner surface and an outer surface; and applying radiation to crosslink the outer surface of the tube, wherein the outer surface of the tube is crosslinked and the inner surface of the tube is not crosslinked.

In a particular embodiment, a multilayer tube includes an inner fluoropolymer layer comprising a terpolymer of tetrafluoroethylene, hexafluoropropylene, and vinylidene fluoride (THV); and an outer fluoropolymer layer of a poly vindylidene fluoride (PVDF), an expanded poly vindylidene fluoride (PVDF), a terpolymer of tetrafluoroethylene, hexafluoropropylene, vinylidene fluoride (THV), an expanded terpolymer of tetrafluoroethylene, hexafluoropropylene, vinylidene fluoride (THV), or combination thereof, wherein the outer fluoropolymer layer is crosslinked and the inner fluoropolymer layer is not crosslinked.

In another embodiment, a tube includes a single fluoropolymer layer of a terpolymer including tetrafluoroethylene, hexafluoropropylene, and vinylidene fluoride (THV), the tube having an outer surface that is crosslinked and an inner surface that is not crosslinked.

### BRIEF DESCRIPTION OF THE DRAWINGS

The present disclosure may be better understood, and its numerous features and advantages made apparent to those skilled in the art by referencing the accompanying drawings.

FIG. 1 includes an illustration of an exemplary tube according to an embodiment.

FIG. 2 includes an illustration of an exemplary multilayer tube according to an embodiment.

The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises”, “comprising”, “includes”, “including”, “has”, “having” or any other variation thereof, are open-ended terms and should be interpreted to mean “including, but not limited to . . . .” These terms encompass the more restrictive terms “consisting essentially of” and “consisting of” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at about 23° C.+/−5° C. per ASTM, unless indicated otherwise.

According to one embodiment, a tube includes at least one layer including a fluoropolymer. In an embodiment, the at least one fluoropolymer layer has a heat shrink temperature of less than 250° C. The tube can encapsulate at least a portion of a sensor to protect at least a portion of the sensor from environmental contaminants and conditions. At least a portion of the sensor is encapsulated by the tube and the tube can be subjected to a thermal source to heat shrink the tube around the sensor. In an embodiment, “encapsulate” as used herein refers to providing a barrier to a gas, a liquid, a solid, or combination thereof to the portion of the sensor that is in direct contact with the heat-shrunk tube. In an embodiment, the tube has an outer surface and an inner surface, where the outer surface of the tube is crosslinked and the inner surface of the tube is not crosslinked.

According to one embodiment, the tube can be comprised of a fluoropolymer. An exemplary fluoropolymer may be formed of a homopolymer, copolymer, terpolymer, or polymer blend formed from at least one monomer including fluorine, such as tetrafluoroethylene, hexafluoropropylene, chlorotrifluoroethylene, trifluoroethylene, vinylidene fluoride, vinylidene difluoride, vinyl fluoride, perfluoropropyl vinyl ether, perfluoromethyl vinyl ether, or any combination thereof. In an embodiment, the fluoropolymer includes a monomer including tetrafluoroethylene, hexafluoropropylene, vinylidene fluoride, or combination thereof. In a particular embodiment, the fluoropolymer includes a poly vindylidene fluoride (PVDF), a terpolymer of tetrafluoroethylene, hexafluoropropylene, and vinylidene difluoride (THV), or combination thereof.

Typically, the fluoropolymer includes any nominal fluorine content envisioned. In an embodiment, the nominal fluorine content is greater than about 60 weight %, such as about 60 weight % to about 80 weight %, or even about 60 weight % to about 70 weight %. It will be appreciated that the nominal fluorine content can be within a range between any of the minimum and maximum values noted above.

In a further embodiment, the fluoropolymer of the tube may include any additive envisioned. The additive may include, for example, a curing agent, an antioxidant, a filler, an ultraviolet (UV) agent, a dye, a pigment, an anti-aging agent, a plasticizer, the like, or combination thereof. In an embodiment, the curing agent is a cross-linking agent provided to increase and/or enhance crosslinking of the fluoropolymer. In a further embodiment, the use of a curing agent may provide desirable properties such as decreased permeation of small molecules and improved elastic recovery of the material compared to a material that does not include a curing agent. Any curing agent is envisioned such as, for example, a dihydroxy compound, a diamine compound, an organic peroxide, or combination thereof. An exemplary dihydroxy compound includes a bisphenol AF. An exemplary diamine compound includes hexamethylene diamine carbamate. In an embodiment, the curing agent is an organic peroxide. Any amount of curing agent is envisioned. Any reasonable filler is envisioned. In an embodiment, the filler may improve properties of the tube such as, for example, thermal conductivity, mechanical properties, and the like. Alternatively, the fluoropolymer may be substantially free of crosslinking agents, curing agents, photoinitiators, fillers, plasticizers, or a combination thereof. “Substantially free” as used herein refers to less than about 1.0% by weight, or even less than about 0.1% by weight of the total weight of the fluoropolymer.

In an embodiment, at least a portion of the tube is crosslinked. For instance, the outer surface of the tube is crosslinked. For instance, through an entire thickness of a tube from the outer surface to the inner surface of the tube, the crosslinking is at a depth of at least 25%, such as at least 50%, or even at least 75% of the total thickness of the tube. In an embodiment, the crosslinking depth is no greater than 90%, such as no greater than 80% of the total thickness of the tube from the outer surface to the inner surface of the tube. In a particular embodiment, the inner surface of the tube is not crosslinked. For instance, the inner surface of the tube is not crosslinked such that the fluoropolymer material of the inner surface melts and reflows when subjected to thermal conditions such as heat at temperatures of 160° C. to 250° C. The crosslinking of the outer surface of the tube provides an outer portion of the tube that shrinks in a radial direction when subjected to the thermal conditions of heat at temperatures of 160° C. to 250° C.

Although not being bound by theory, crosslinking may increase the intramolecular bonds within the material. For instance, the fluoropolymer is a crosslinked terpolymer of tetrafluoroethylene, hexafluoropropylene, and vinylidene difluoride, a crosslinked poly vinylidene fluoride (PVDF), or combination thereof. In a particular embodiment, crosslinking of the fluoropolymer improves the tensile modulus of the final tube. For instance, the crosslinked tube has a tensile modulus of at least 30 ksi, such as at least 35 ksi, or even at least 38 ksi as measured by ASTM D638. Any reasonable method of crosslinking is envisioned. For instance, the fluoropolymer may be cross-linked via radiation such as via ultraviolet radiation, electron-bean radiation, gamma radiation, or combination thereof. In an embodiment, the radiation includes electron beam radiation. In a more particular embodiment, the electron beam radiation is at 0.1 MRad to 80 MRad.

In a particular embodiment, the layer includes at least 70% by weight of the fluoropolymer layer. For example, the layer may include at least 85% by weight fluoropolymer layer, such as at least 90% by weight, at least 95% by weight, or even 100% by weight of the fluoropolymer layer. In an example, the layer may consist essentially of the fluoropolymer layer. In a particular example, the layer may consist essentially of a poly vinylidene fluoride (PVDF), a terpolymer of tetrafluoroethylene, hexafluoropropylene, and vinylidene difluoride, or combination thereof. In an embodiment, the layer may consist essentially of a terpolymer of tetrafluoroethylene, hexafluoropropylene, and vinylidene difluoride. As used herein, the phrase “consists essentially of” used in connection with the fluoropolymer of the layer precludes the presence of other non-fluorinated monomers and fluorinated monomers that affect the basic and novel characteristics of the fluoropolymer, although, commonly used processing agents and additives such as antioxidants, fillers, UV agents, dyes, pigments, anti-aging agents, and any combination thereof may be used in the fluoropolymer. In a particular example, the layer may consist of a poly vinylidene fluoride (PVDF), a terpolymer of tetrafluoroethylene, hexafluoropropylene, and vinylidene difluoride, or combination thereof. In a particular example, the layer may consist of a terpolymer of tetrafluoroethylene, hexafluoropropylene, and vinylidene difluoride.

In further reference to the tube, according to one embodiment, at least the outer surface of the fluoropolymer of the tube is made from a material having a heat shrink temperature of less than 250° C. In an embodiment, at least the outer surface of the fluoropolymer of the tube has a heat shrink temperature of about 160° C. to about 250° C. In comparison, typical commercially available heat shrink tubing have a heat shrink temperature of greater than 300° C. Advantageously and as described, when heat is applied in a range of about 160° C. to about 250° C., the outer surface of the tube shrinks in a radial direction and squeezes the tube to decrease the overall outside diameter of the tube. The heat applied further melts the inner surface of the tube such that the fluoropolymer of the inner surface reflows and can encapsulate a component, such as a sensor, while the tube shrinks.

In an embodiment, the fluoropolymer can be expanded. The expanded fluoropolymer of the disclosure has an expansion ratio, defined as the ratio of the stretched dimension to the unstretched dimension, of not greater than about 4:1, such as not greater than about 3:1, not greater than about 2.5:1, or not greater than about 2:1. In an example, the expanded fluoropolymer may be uniaxially stretched. Alternatively, the expanded fluoropolymer may be biaxially stretched. In particular, the expansion ratio may be between about 1.5:1 and about 2.5:1, such as about 2:1. In an exemplary embodiment, the heat-shrinkable fluoropolymer is not stretched to a node and fibril structure. In contrast, expanded fluoropolymer is generally biaxially expanded at ratios of about 4:1 to form node and fibril structures. Hence, the heat-shrinkable fluoropolymer of the disclosure maintains chemical resistance as well as flexibility.

According to one embodiment, the tube is hollow, thin-walled and has a fine geometry, having an ID (inner diameter) within a range of about 0.1 mm to about 18.0 mm, such as 0.1 mm to about 15.0 mm, or 0.5 mm to about 15.0 mm. OD (outside diameter) is generally within a range of about 0.25 mm to 20.0 mm, such as 1.0 mm to 15.0 mm, or 1.0 mm to 10.0 mm. Generally, the tube has a uniform wall thickness, within a range of about 0.05 mm to about 3.0 mm, such as 0.1 mm to 1.0 mm, and most often within a range of about of 0.1 mm to 0.75 mm. It will be appreciated that the ID, OD, and wall thickness can be within a range between any of the minimum and maximum values noted above.

In a particular embodiment, the fluoropolymer layer may be provided by any method envisioned and is dependent upon the fluoropolymer material chosen. In an embodiment, the fluoropolymer material is melt processable. “Melt processable” as used herein refers to a fluoropolymer material that can melt and flow to extrude in any reasonable form such as films, tubes, fibers, molded articles, or sheets. For instance, the melt processable fluoropolymer material is a flexible material. In an embodiment, the fluoropolymer material is extruded, injection molded, or mandrel wrapped. In an exemplary embodiment, the fluoropolymer material is extruded. The layer may be cured in place using a variety of curing techniques such as via heat, radiation, or any combination thereof.

According to a particular feature, embodiments may be produced utilizing any reasonable extrusion process. In a particular embodiment, the tube is a single layer of the fluoropolymer material. In another embodiment, the tube includes multiple layers of the same or different fluoropolymer materials.

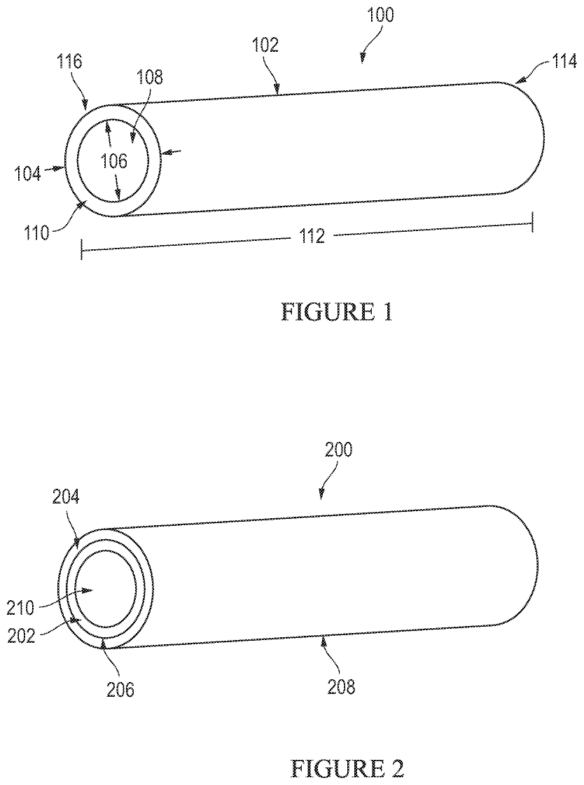

FIG. 1 is a view of a tube 100 according to an embodiment. In a particular embodiment, the tube 100 can include a body 102 having an outside diameter 104 and an inner diameter 106. The inner diameter 106 can form a hollow bore 108 of the body 102. The hollow bore 108 defines a central lumen of the tube. In addition, the body 102 is illustrated as a single layer, the single layer including a fluoropolymer layer, the fluoropolymer layer including the fluoropolymer described above. The fluoropolymer layer can include a layer thickness 110 that is measured by the difference between the outside diameter 104 and the inner diameter 106.

Further, the body 102 can have a length 112, which is a distance between a distal end 114 and a proximal end 116 of the tube 100. In a further embodiment, the length 112 of the body 102 can be at least about 2 centimeters (cm), such as at least about 5 cm, such as at least about 8 cm. The length 112 is generally limited by pragmatic concerns, such as storing and transporting long lengths, or by customer demand.

Although the cross-section of the hollow bore 108 perpendicular to an axial direction of the body 102 in the illustrative embodiment shown in FIG. 1 has a circular shape, the cross-section of the hollow bore 108 perpendicular to the axial direction of the body 102 can have any cross-section shape envisioned.

In a particular embodiment, the single layer tube including the fluoropolymer is provided by any method envisioned. For instance, the fluoropolymer may be provided by any method envisioned and is dependent upon the fluoropolymer chosen for the single layer tube. In an embodiment, the fluoropolymer of the layer is extruded, injection molded, or mandrel wrapped. In an exemplary embodiment, the fluoropolymer is extruded. Further, the layer may be cured in place using a variety of curing techniques such as via heat, radiation, or any combination thereof. Additionally, the fluoropolymer may be expanded by any method envisioned. In an embodiment, the tube consists essentially of a single layer. As used herein, the phrase “consists essentially of” used in connection with the single layer of the tube precludes the presence of other layers that affect the basic and novel characteristics of the final tube. In an embodiment, the tube consists of a single layer. In particular embodiment, the single layer tube is a terpolymer of tetrafluoroethylene, hexafluoropropylene, and vinylidene fluoride (THV). In an embodiment, the terpolymer of tetrafluoroethylene, hexafluoropropylene, and vinylidene fluoride (THV) is expanded.

As a single layer tube, at least a portion of a thickness of the tube is crosslinked, as described above. For instance, the crosslinking of the tube 100 is at a depth of at least 25%, such as at least 50%, or even at least 75% of the total thickness of the tube. In an embodiment, the crosslinking depth is no greater than 90%, such as no greater than 80% of the total thickness of the tube from the outer surface to the inner surface of the tube. In an embodiment, the fluoropolymer layer may be cross-linked via radiation such as via ultraviolet radiation, electron-bean radiation, gamma radiation, or combination thereof. In an embodiment, the radiation includes electron beam radiation. In a more particular embodiment, the electron beam radiation is at 0.1 MRad to 80 MRad. Further, the inner surface of the tube is not crosslinked.

In an alternative embodiment, the tube includes multiple layers. In an embodiment, the tube includes multiple layers of a fluoropolymer material. For instance, the multilayer tube includes an inner layer including a first material and an outer layer of a second material. In a particular embodiment, the first material and the second material are the same material. In an embodiment, the first material and the second material are different materials. In an embodiment, different materials may be used for the first material and the second material having the same or different thicknesses. In an embodiment, the first material and the second material include a fluoropolymer as described above.

In an alternative embodiment and as seen in FIG. 2, a multilayer tube 200 is an elongated annular structure with a hollow central bore. The multilayer tube 200 includes an inner layer 202 and an outer layer 204. The outer layer 204 is illustrated as overlying the inner layer 202. The inner layer 202 may be directly in contact with and may directly bond to the outer layer 204 along an outer surface 206 of the inner layer 202. As illustrated, the outer layer 204 provides an outside surface 208 of the multilayer tube 200. In an example, the inner layer 202 may directly contact the outer layer 204 without intervening adhesive layers, such as a primer.

As illustrated, the inner layer 202 includes an inner surface 210 that defines a central lumen of the tube. In an embodiment, the outer layer 204 includes a fluoropolymer, as described above. In an embodiment, the inner layer 202 may be the same or different material than the outer layer 204. For instance, the inner layer 202 may include the same or different polymer as the outer layer 204.

In an example, the inner layer 202 is a fluoropolymer. In an example, the inner layer 202 is an exemplary fluoropolymer as described above. In a particular embodiment, the inner layer 202 is a terpolymer of tetrafluoroethylene, hexafluoropropylene, and vinylidene fluoride (THV). In an example, the outer layer 204 is a fluoropolymer as described above. In a particular embodiment, the outer layer 204 is a poly vinylidene fluoride, a terpolymer of tetrafluoroethylene, hexafluoropropylene, and vinylidene fluoride (THV), or combination thereof. Furthermore, the fluoropolymer of the outer layer 204 is crosslinked. In a more particular embodiment, the fluoropolymer of the outer layer 204 may be expanded. In an embodiment, the outer layer 204 is the terpolymer of tetrafluoroethylene, hexafluoropropylene, and vinylidene fluoride (THV) that may be crosslinked and/or expanded. In a particular embodiment, the multilayer tube 200 with an outer layer 204 of the terpolymer has an advantageous transparency. In an embodiment, the transparency of the tube is improved compared to a tube including polytetrafluoroethylene (PTFE), fluorinated ethylene propylene (FEP), a copolymer of tetrafluoroethylene and perfluoropropyl vinyl ether (PFA), or combination thereof.

Any dimensions of the multilayer tube 200 are envisioned. For instance, any thickness of the layers 202, 204 is envisioned and is typically dependent upon the final properties desired for the multilayer tube 200. In an embodiment, the ratio of the thickness of the inner layer 202 to the outer layer 204 may be 20:1 to 1:20, such as 10:1 to 1:10, such as 5:1 to 1:5, such as 2:1 to 1:2, or even 1:1. It will be appreciated that the ratio of the thickness can be within a range between any of the minimum and maximum values noted above.

Although illustrated as a single layer tube and a two layer tube, any number of layers is envisioned. For instance, the tube includes one layer, two layers, three layers, or even a greater number of layers. Irrespective of the number of layers present, the outside diameter and inner diameter of the tube can have any values as defined for the tube. The number of layers is dependent upon the final properties desired for the tube.

In an embodiment, the tube may further include other layers such as, for example, a polymeric layer, a reinforcing layer, an adhesive layer, a barrier layer, a chemically resistant layer, a metal layer, any combination thereof, and the like. Any reasonable method of providing any additional layer is envisioned and is dependent upon the material chosen. For instance, the additional layer may be an additional polymeric layer of a thermoplastic elastomer that may or may not be extruded. In an embodiment, any number of polymeric layers is envisioned. Any number of layers is also envisioned. Further, irrespective of the number of layers, the crosslinked layer is typically disposed on the outer surface of the tube. In an embodiment, the tube consists essentially of the inner layer and the outer layer. As used herein, the phrase “consists essentially of” used in connection with the tube precludes the presence of other layers that affect the basic and novel characteristics of the heat shrink capabilities of the final tube. In an embodiment, the tube consists of the inner layer and the outer layer.

In a particular embodiment, the multilayer tube is formed by providing the inner layer including the fluoropolymer. The fluoropolymer may be provided by any method envisioned and is dependent upon the fluoropolymer chosen for the inner layer. In an embodiment, the fluoropolymer of the inner layer is extruded, injection molded, or mandrel wrapped. In an exemplary embodiment, the fluoropolymer is extruded. Further, the inner layer may be cured in place using a variety of curing techniques such as via heat, radiation, or any combination thereof.

The outer layer includes a fluoropolymer as described above. The fluoropolymer may be provided by any method envisioned and is dependent upon the fluoropolymer chosen for the outer layer. The method may further include providing the outer layer by any method. Providing the outer layer depends on the fluoropolymer material chosen for the outer layer. In an embodiment, the outer layer is extruded, injection molded, or mandrel wrapped. In an exemplary embodiment, the outer layer may be extruded. Further, the outer layer may be cured in place using a variety of curing techniques such as via heat, radiation, or any combination thereof. Additionally, the fluoropolymer of the outer layer may be expanded by any method envisioned.

In an embodiment, the outer layer is separately extruded from the inner layer and the inner layer is positioned within the outer layer after extrusion. In an embodiment, the outer layer is extruded over the inner layer. Further, the layers may be cured using a variety of curing techniques such as via heat, radiation, or any combination thereof. In an embodiment, the inner layer and the outer layer may be co-extruded. In an exemplary embodiment, the inner layer is provided by heating the fluoropolymer to an extrusion viscosity and the outer layer is provided by heating the fluoropolymer to an extrusion viscosity. When the tube includes multiple layers, any order of extruding the layers together or individually is envisioned.

Advantageously, the inner layer and the outer layer may also be bonded together (e.g. coextruded) at the same time, which may enhance the adhesive strength between the layers. In particular, the inner layer and the outer layer have cohesive strength between the two layers, i.e. cohesive failure occurs wherein the structural integrity of the inner layer and the outer layer fails before the bond between the two layers fails. In a particular embodiment, the adhesive strength between the inner layer and the outer layer is cohesive.

In an embodiment, at least one layer may be treated to improve adhesion between the inner layer and the outer layer. Any treatment is envisioned that increases the adhesion between two adjacent layers. For instance, a surface of the inner layer that is directly adjacent to the outer layer may be treated. Further, a surface of the outer layer that is directly adjacent to the inner layer may be treated. In an embodiment, the treatment may include surface treatment, chemical treatment, sodium etching, use of a primer, or any combination thereof. In an embodiment, the treatment may include corona treatment, UV treatment, electron beam treatment, gamma treatment, flame treatment, scuffing, sodium naphthalene surface treatment, or any combination thereof.

As a multilayer tube, at least a portion of a thickness of the tube is crosslinked, as described above. In an embodiment, the crosslinking of the tube 200 is at a depth of at least 25%, such as at least 50%, or even at least 75% of the total thickness of the tube. In an embodiment, the crosslinking depth is no greater than 90%, such as no greater than 80% of the total thickness of the tube from the outer surface to the inner surface of the tube. In an embodiment, the outer layer of the fluoropolymer is crosslinked. In an embodiment, the outer layer of the fluoropolymer may be cross-linked via radiation such as via ultraviolet radiation, electron-bean radiation, gamma radiation, or combination thereof. In an embodiment, the radiation includes electron beam radiation. In a more particular embodiment, the electron beam radiation is at 0.1 MRad to 80 MRad. Further, the inner surface of the tube is not crosslinked. In an embodiment, the inner layer of the tube is not crosslinked.

In an embodiment, any post-cure steps may be envisioned. In particular, the post-cure step includes any treatment that may improve or enhance to properties of the tube. In an embodiment, the post-cure step includes thermal treatment. Any thermal conditions are envisioned.

In an example, the tube may be used to encapsulate at least a portion of a sensor. Once the tube is formed, a sensor is provided within the lumen of the tube. Heat is applied to the outer surface to heat shrink the tube around the sensor and melt the material of the inner surface. Although a sensor is generally described, any component that needs protection from an environment is envisioned.

Although generally described as a tube, any reasonable polymeric article can be envisioned. The polymeric article may alternatively take the form of a film, a washer, or a fluid conduit. For example, the polymeric article may take the form or a film or a planar article. In another example, the polymeric article may take the form of a conduit, such as tubing. In a particular embodiment, the polymeric article can be used where chemical resistance and/or low permeation to gases and hydrocarbons are desired.

Applications for the tubing are numerous. In an exemplary embodiment, the tubing may be used in applications where sensors and/or electrical components need protection. In an embodiment, the sensor can be a thermocouple, a thermoresistor, and the like. In an embodiment, the tube has advantageous thermal conductivity properties. In another embodiment, the heat-shrink tube can be used to protect an electrical wire connection, a splice, a connector, and the like. For instance, the tube can be used for household wares, industrial, wastewater, digital print equipment, automotive, or other applications where chemical resistance and/or low permeation to gases and hydrocarbons are desired.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. A tube includes at least one fluoropolymer layer, the tube having an inner surface and an outer surface, wherein the at least one fluoropolymer layer includes a fluoropolymer having a heat shrink temperature of less than 250° C., wherein the outer surface of the tube is crosslinked and the inner surface of the tube is not crosslinked.

Embodiment 2. A method of forming a tube includes providing a fluoropolymer having a heat shrink temperature of less than 250° C.; extruding the fluoropolymer into at least one fluoropolymer layer, the tube having an inner surface and an outer surface; and applying radiation to crosslink the outer surface of the tube, wherein the outer surface of the tube is crosslinked and the inner surface of the tube is not crosslinked.

Embodiment 3. The tube or the method of forming the tube of any of the preceding embodiments, wherein the fluoropolymer includes a monomer including tetrafluoroethylene, hexafluoropropylene, vinylidene fluoride, or combination thereof.

Embodiment 4. The tube or the method of forming the tube of any of the preceding embodiments, wherein the fluoropolymer includes a poly vindylidene fluoride (PVDF), a terpolymer of tetrafluoroethylene, hexafluoropropylene, vinylidene fluoride (THV), or combination thereof.

Embodiment 5. The tube or the method of forming the tube of any of the preceding embodiments, wherein the tube includes a single layer of a terpolymer of tetrafluoroethylene, hexafluoropropylene, and vinylidene fluoride (THV).

Embodiment 6. The tube or the method of forming the tube of any of the preceding embodiments, wherein the terpolymer of tetrafluoroethylene, hexafluoropropylene, and vinylidene fluoride (THV) is expanded.

Embodiment 7. The tube or the method of forming the tube of any one of embodiments 1-4, wherein the tube includes an inner fluoropolymer layer and an outer fluoropolymer layer.

Embodiment 8. The tube or the method of forming the tube of embodiment 7, wherein the inner fluoropolymer layer includes a terpolymer of tetrafluoroethylene, hexafluoropropylene, and vinylidene fluoride (THV).

Embodiment 9. The tube or the method of forming the tube of embodiment 7, wherein the outer fluoropolymer layer includes a poly vindylidene fluoride (PVDF), a terpolymer of tetrafluoroethylene, hexafluoropropylene, vinylidene fluoride (THV), or combination thereof.

Embodiment 10. The tube or the method of forming the tube of embodiment 9, wherein the outer fluoropolymer layer includes an expanded poly vinylidene fluoride (PVDF), an expanded terpolymer of tetrafluoroethylene, hexafluoropropylene, vinylidene fluoride (THV), or combination thereof.

Embodiment 11. The tube or the method of forming the tube of embodiment 10, wherein the expanded fluoropolymer layer has an expansion ratio of about 1.5:1 to about 2.5:1, or even about 2:1.

Embodiment 12. The tube or the method of forming the tube of embodiments 7-11, wherein the outer fluoropolymer layer includes a terpolymer of tetrafluoroethylene, hexafluoropropylene, vinylidene fluoride (THV).

Embodiment 13. The tube or the method of forming the tube of embodiment 12, wherein the tube has an improved transparency compared to a tube including PTFE, FEP, PFA, or combination thereof.

Embodiment 14. The tube or the method of forming the tube of embodiment 7, wherein the inner fluoropolymer layer is directly in contact with the outer fluoropolymer layer.

Embodiment 15. The tube or the method of forming the tube of any of the preceding embodiments, wherein the outer surface is crosslinked via radiation.

Embodiment 16. The tube or the method of forming the tube of embodiment 15, wherein radiation includes ultraviolet radiation, electron-beam radiation, gamma radiation, or combination thereof.

Embodiment 17. The tube or the method of forming the tube of any of the preceding embodiments, wherein the tube has an outside diameter within a range of about 0.25 mm to about 20.0 mm, such as a range of about 1.0 mm to about 15.0 mm, such as a range of about 1.0 mm to about 10.0 mm.

Embodiment 18. The tube or the method of forming the tube of any of the preceding embodiments, wherein the tube has an inner diameter within a range of about 0.1 mm to about 18.0 mm, such as about 0.1 mm to about 15.0 mm, or even about 0.5 mm to about 15.0 mm.

Embodiment 19. The tube or the method of forming the tube of any of the preceding embodiments, wherein the crosslinking is at a depth of at least 25%, such as at least 50%, or even at least 75% of the total thickness of the tube from the outer surface to the inner surface of the tube.

Embodiment 20. The tube or the method of forming the tube of any of the preceding embodiments, wherein the inner surface melts at a temperature of about 160° C. to 250° C.

Embodiment 21. The tube or the method of forming the tube of any of the preceding embodiments, wherein the tube encapsulates at least a portion of a sensor.

Embodiment 22. The method of forming the tube of embodiment 2, wherein extruding the fluoropolymer includes extruding an inner fluoropolymer layer and extruding an outer fluoropolymer layer.

Embodiment 23. The method of forming the tube of embodiment 22, further including the step of expanding the extruded outer fluoropolymer layer.

Embodiment 24. The method of forming the tube of embodiment 22, further including the step of positioning the outer fluoropolymer layer over the inner fluoropolymer layer.

Embodiment 25. A multilayer tube includes: an inner fluoropolymer layer including a terpolymer of tetrafluoroethylene, hexafluoropropylene, and vinylidene fluoride (THV); and an outer fluoropolymer layer of a poly vindylidene fluoride (PVDF), an expanded poly vindylidene fluoride (PVDF), a terpolymer of tetrafluoroethylene, hexafluoropropylene, vinylidene fluoride (THV), an expanded terpolymer of tetrafluoroethylene, hexafluoropropylene, vinylidene fluoride (THV), or combination thereof, wherein the outer fluoropolymer layer is crosslinked and the inner fluoropolymer layer is not crosslinked.

Embodiment 26. The multilayer tube of embodiment 25, wherein the outer fluoropolymer layer is crosslinked via radiation.

Embodiment 27. The multilayer tube of embodiment 26, wherein radiation includes ultraviolet radiation, electron-beam radiation, gamma radiation, or combination thereof.

Embodiment 28. A tube includes a single fluoropolymer layer of a terpolymer including tetrafluoroethylene, hexafluoropropylene, and vinylidene fluoride (THV), the tube having an outer surface that is crosslinked and an inner surface that is not crosslinked.

Embodiment 29. The tube of embodiment 28, wherein the crosslinking is at depth of at least 25%, such as at least 50%, or even at least 75% of the total thickness of the tube from the outer surface to the inner surface of the tube.

Embodiment 30. The tube of embodiment 28, wherein the outer surface is crosslinked via radiation.

Embodiment 31. The tube of embodiment 30, wherein radiation includes ultraviolet radiation, electron-beam radiation, gamma radiation, or combination thereof.

Embodiment 32. The tube of embodiment 28, wherein the terpolymer including tetrafluoroethylene, hexafluoropropylene, and vinylidene fluoride (THV) is expanded.

Embodiment 33. A method of forming an encapsulated sensor includes: providing a fluoropolymer having a heat shrink temperature of less than 250° C.; extruding the fluoropolymer into at least one layer having an inner surface and an outer surface, the inner surface defining a lumen; applying radiation to crosslink the outer surface, wherein the outer surface is crosslinked and the inner surface of the layer is not crosslinked; providing a sensor within the lumen; and applying heat to the outer surface to heat shrink the tube around the sensor.

Embodiment 34. The method of forming the encapsulated sensor of embodiment 33, wherein radiation includes ultraviolet radiation, electron-beam radiation, gamma radiation, or combination thereof.

Embodiment 35. The method of forming the encapsulated sensor of embodiment 33, wherein the fluoropolymer includes a monomer including tetrafluoroethylene, hexafluoropropylene, vinylidene fluoride, or combination thereof.

Embodiment 36. The method of forming the encapsulated sensor of embodiment 35, wherein the fluoropolymer includes a poly vinylidene fluoride (PVDF), a terpolymer of tetrafluoroethylene, hexafluoropropylene, vinylidene fluoride (THV), or combination thereof.

Embodiment 37. The method of forming the encapsulated sensor of embodiment 33, wherein extruding the fluoropolymer includes extruding an inner fluoropolymer layer and extruding an outer fluoropolymer layer, wherein the inner fluoropolymer layer and the outer fluoropolymer layer includes a monomer including tetrafluoroethylene, hexafluoropropylene, vinylidene fluoride, or combination thereof.

Embodiment 38. The method of forming the encapsulated sensor of embodiment 37, further including the step of expanding the extruded outer fluoropolymer layer.

Embodiment 39. The method of forming the encapsulated sensor of embodiment 37, further comprising the step of positioning the outer fluoropolymer layer over the inner fluoropolymer layer.

Embodiment 40. The method of forming the encapsulated sensor of embodiment 33, wherein the heat applied to heat shrink the outer surface is a temperature of about 160° C. to 250° C.

The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

Several samples of 2-layer tubes are produced and can be seen in Table 1. The inner layer is THV that is not irradiated. The THV for the inner and outer layer have a melting point of about 225° C. with a shrink temperature of less than 225° C. PVDF has a melting point of about 170° C. and a shrink temperature of about 170° C. Expansion of the outer layer material is about 2:1.

TABLE 1

| Sample | Outer layer material | E-beam level (MRads) |
|---|---|---|
| 1 | Expanded THV | No irradiation |
| 2 | Expanded THV | 30 |
| 3 | Expanded THV | 60 |
| 4 | Expanded PVDF | No irradiation |
| 5 | Expanded PVDF | 30 |
| 6 | Expanded PVDF | 60 |

Samples of a monolayer tube is provided of THV can be seen in Table 2. The THV has a melting point of about 225° C. with a shrink temperature of less than 225° C.

TABLE 2

| Sample | E-beam level (MRads) |
|---|---|
| 7 | No irradiation |
| 8 | 30; to an outer cure depth of about 60% from outer layer |
| 9 | 60, to an outer cure depth of about 60% from outer layer |

All 9 samples can be heat shrunk to encapsulate a sensor.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A tube comprises:
at least one fluoropolymer layer, the tube having an inner surface and an outer surface, wherein the at least one fluoropolymer layer comprises a fluoropolymer having a heat shrink temperature of less than 250° C., wherein the outer surface of the tube is crosslinked and the inner surface of the tube is not crosslinked.

2. The tube in accordance with claim 1, wherein the fluoropolymer comprises a monomer comprising tetrafluoroethylene, hexafluoropropylene, vinylidene fluoride, or combination thereof.

3. The tube in accordance with claim 1, wherein the fluoropolymer comprises a poly vindylidene fluoride (PVDF), a terpolymer of tetrafluoroethylene, hexafluoropropylene, vinylidene fluoride (THV), or combination thereof.

4. The tube in accordance with claim 1, wherein the tube comprises a single layer of a terpolymer of tetrafluoroethylene, hexafluoropropylene, and vinylidene fluoride (THV).

5. The tube in accordance with claim 4, wherein the terpolymer of tetrafluoroethylene, hexafluoropropylene, and vinylidene fluoride (THV) is expanded.

6. The tube in accordance with claim 1, wherein the tube comprises an inner fluoropolymer layer and an outer fluoropolymer layer.

7. The tube in accordance with claim 6, wherein the inner fluoropolymer layer comprises a terpolymer of tetrafluoroethylene, hexafluoropropylene, and vinylidene fluoride (THV).

8. The tube in accordance with claim 6, wherein the outer fluoropolymer layer comprises a poly vindylidene fluoride (PVDF), a terpolymer of tetrafluoroethylene, hexafluoropropylene, vinylidene fluoride (THV), or combination thereof.

9. The tube in accordance with claim 8, wherein the outer fluoropolymer layer is expanded.

10. The tube in accordance with claim 6, wherein the inner fluoropolymer layer is directly in contact with the outer fluoropolymer layer.

11. The tube in accordance with claim 1, wherein the outer surface is crosslinked via radiation.

12. The tube in accordance with claim 11, wherein radiation comprises ultraviolet radiation, electron-beam radiation, gamma radiation, or combination thereof.

13. The tube in accordance with claim 1, wherein the crosslinking is at a depth of at least 25% of the total thickness of the tube from the outer surface to the inner surface of the tube.

14. The tube in accordance with claim 1, wherein the inner surface melts at a temperature of about 160° C. to 250° C.

15. The tube in accordance with claim 1, wherein the tube encapsulates at least a portion of a sensor.

16. A method of forming a tube comprises:
providing a fluoropolymer having a heat shrink temperature of less than 250° C.;
extruding the fluoropolymer into at least one fluoropolymer layer, the tube having an inner surface and an outer surface; and
applying radiation to crosslink the outer surface of the tube, wherein the outer surface of the tube is crosslinked and the inner surface of the tube is not crosslinked.

17. The method of forming the tube of claim 16, wherein extruding the fluoropolymer comprises extruding an inner fluoropolymer layer and extruding an outer fluoropolymer layer.

18. The method of forming the tube of claim 17, further comprising the step of expanding the extruded outer fluoropolymer layer.

19. A multilayer tube comprises:
an inner fluoropolymer layer comprising a terpolymer of tetrafluoroethylene, hexafluoropropylene, and vinylidene fluoride (THV); and
an outer fluoropolymer layer of a poly vindylidene fluoride (PVDF), an expanded poly vindylidene fluoride (PVDF), a terpolymer of tetrafluoroethylene, hexafluoropropylene, vinylidene fluoride (THV), an expanded terpolymer of tetrafluoroethylene, hexafluoropropylene, vinylidene fluoride (THV), or combination thereof, wherein the outer fluoropolymer layer is crosslinked and the inner fluoropolymer layer is not crosslinked.

20. The multilayer tube of claim 19, wherein the outer fluoropolymer layer is crosslinked via radiation.
